(19) United States
(12) Patent Application Publication
(10) Pub. No.: US 2008/0246296 A1
(43) Pub. Date: Oct. 9, 2008

(54) Static-Reducing Vehicle Seat

(75) Inventors: Diane K. McQueen, Leonard, MI (US); Jennifer P. Lawall, Waterford, MI (US); Steven E. Morris, Fair Haven, MI (US); James N. Contes, Tempe, AZ (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/695,738

(22) Filed: Apr. 3, 2007

(51) Int. Cl. B60N 2/00; H05F 3/00

(52) U.S. Cl. 296/63

(57) ABSTRACT

A vehicle seat is provided having at least one seat cushion for carrying a vehicle occupant, and having a static-reducing device positioned in sufficient proximity to the occupant for dissipating an electrostatic charge from the seat. The static-reducing device includes conductive threading woven into the seat cushion or into piping along the seat cushion seams, conductive wiring connected to the base to form a conductive path for dissipating the electrostatic charge, or a humidity-absorbing layer. A vehicle is also provided having a floor and a vehicle seat having a cushion and a base mounted to the floor. The cushion is operatively connected to the base and has a static-reducing device adapted to reduce electrostatic charge of the seat to thereby minimize the electrostatic discharge between the seat and a passenger when the passenger exits the vehicle, the static-reducing device including conductive threading, conductive wiring, or a humidity-absorbing mat.

### TECHNICAL FIELD

This invention relates to a vehicle seat configured for minimizing, neutralizing, or dissipating an electrostatic charge from the surfaces of the seat to thereby prevent an electrostatic discharge between a passenger and the vehicle.

### BACKGROUND OF THE INVENTION

Electrostatic discharge, or ESD, is the rapid transfer of an electrostatic charge resulting from the proximate or direct contact between two bodies or objects having different electric potentials. ESD may be caused by a number of environmental and physical factors, including static generated by various materials of construction and/or relative motion of the two bodies, low humidity, and/or improper or inadequate grounding. Negative and positive charges are created in the two bodies or objects when separation of the two bodies or objects occurs. These charges are then driven to neutralize themselves by seeking a “ground”. Thus, ESD occurs when the body or object comes in proximity to a conductive material offering a path to ground. ESD control devices therefore exist for the purpose of reducing the potential for static build-up and/or to provide a grounding path for harmlessly discharging a built-up static charge, or for discharging a static charge well before a substantial charge may build. Such devices may include grounding straps, ESD-prevention smocks or other anti-ESD clothing, and humidifiers.

As it relates to automotive vehicles, ESD is most commonly experienced as the shock that results when a vehicle passenger or occupant touches a door handle or other metal component upon exiting or alighting from the vehicle. Various devices exist for controlling the effects of ESD in automotive vehicles, with varying effectiveness. For example, conductive tires or grounding straps attached to the frame may be used in an attempt to dissipate the static charge from a vehicle. However, such devices may be less than optimal due to wear of the device, such as a strap dragging along the ground beneath the vehicle, cost, inconvenience, and/or unattractive appearance.

### SUMMARY OF THE INVENTION

Accordingly, a static-reducing seat is provided for carrying an occupant within a vehicle, the seat including a base and a seat cushion having a static-reducing device positioned in sufficient proximity to an occupant in the seat in order to dissipate an electrostatic charge on the seat.

In one aspect of the invention, the static-reducing device is selected from the group of conductive threading, conductive wiring, and a humidity-absorbing layer.

In another aspect of the invention, conductive threading is woven into the outer surfaces of a seat cover of a seat cushion.

In another aspect of the invention, the seat base is conductive, and conductive wiring is connected to the conductive base to form a conductive path for dissipating the electrostatic charge.

In another aspect of the invention, a humidity-absorbing layer is positioned beneath the seat cover and adapted for absorbing humidity from an occupant and from a vehicle compartment to thereby reduce the build-up of an electrostatic charge on the surface of the seat cushion.

The above objects, features and advantages, and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a side view of a vehicle illustrating a condition creating an electrostatic charge and a static-reducing vehicle seat according to the invention;

FIG. 2 is a perspective front view of a vehicle seat having a static-reducing cushion with integrated conductive threading;

FIG. 3 is a perspective front view of a vehicle seat having a humidity-absorbing mat;

FIG. 4 is a perspective front view of a static-reducing vehicle seat having conductive seam piping;

FIG. 5A is a perspective front view of a static-reducing vehicle seat having at least one conductive grounding wire mounted to the seat cushion; and

FIG. 5B is a perspective side view of the vehicle seat of FIG. 5A.

### DESCRIPTION OF THE PREFERRED EMBODIMENTS

Referring to FIG. 1, a vehicle 10 is shown having wheels 12 in rolling contact with a ground surface 14, such as a paved, gravel, or dirt roadway. The vehicle 10 is equipped with a passenger compartment 11 having a floor pan or floor 18 substantially spanning the passenger compartment 11. The floor 18 is preferably constructed of one or more stamped or formed pieces of conductive metal, but may also be constructed of any suitable material capable of conducting an electric charge as described herein.

Within the passenger compartment 11, an anti-static or static-reducing seat 20 is configured to carry a driver, passenger, or other occupant 15, and is mounted or fastened to a seat base or frame 16, which in turn is bolted or otherwise securely fastened to the floor 18. The static-reducing seat 20 is preferably slidably moveable or variably repositionable with respect to the seat frame 16 and floor 18, for example using a seat adjustment lever or electrical seat repositioning device (not shown) adapted to move or reposition the static-reducing seat 20 forward and rearward within the passenger compartment 11 to thereby adjust for different heights and/or driving position preferences of different passengers or occupants 15.

As an occupant 15 operates or drives the vehicle 10, the motion of the vehicle 10, represented by arrow A, and in particular the separation and movement of charged air and dust particles on the surface of the vehicle 10, may act to impart a substantial positive or negative static charge along the surfaces of the vehicle 10. Additionally, in exiting or alighting from the vehicle 10, the motion of an occupant 15 relative to the seat 20, as represented by arrow B in FIG. 1, is often sufficient to generate or produce an unpleasant ESD shock experienced by the occupant 15. As the occupant 15 separates from the seat 20, any electrostatic charge that has been built up in or on the vehicle 10, and particularly on the cushion area of the seat on which the occupant 15 was seated, will create positive and negative charges upon separation, which will then seek to “ground” themselves. As the occupant 15 touches the vehicle 10 upon exiting, particularly when touching a metallic surface, the stored electrostatic charge rapidly discharges or transfers back to the vehicle 10, the transfer manifesting itself as an unpleasant shock.

Turning now to FIG. 2, the static-reducing vehicle seat 20 of the invention is shown having a substantially vertical back cushion 22, and an adjoining seat cushion 21 having outer surfaces forming a seat cover 24. The static-reducing seat 20 is configured or adapted to gradually discharge or transmit an electrical charge from the seat cushion 21 and/or back cushion 22 in small increments that are not perceived or felt by the occupant 15. As described previously hereinabove, the seat cushion 21 is attached to a seat base or frame 16, which in turn is bolted or otherwise rigidly connected to the vehicle floor 18. A web or ESD network 30 of conductive threads 34 are included in the seat cover 24 of seat cushion 21, in an exposed position of sustained contact with an occupant 15. Conductive materials are known in the art, and include any material known to be a relatively efficient conductor of electrical current, such as copper and other conductive metals. The ESD network 30 may include metal and/or fabric blends of conductive threads that may be sewn or otherwise incorporated directly into the upholstery or material of the seat cover 24, i.e. the wrapping or other external textile finishing of the seat cushion 21, preferably in an aesthetically pleasing manner, for example using color-coordinated conductive threads selected to compliment or blend with the other material that makes up the upholstery.

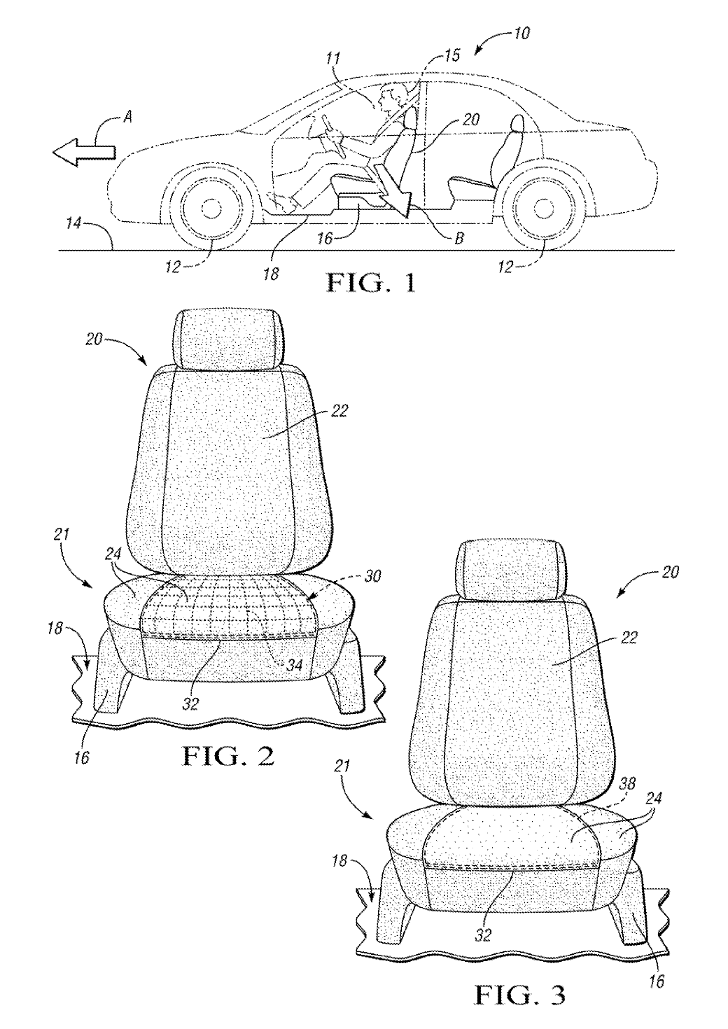

Turning to FIG. 3, a second embodiment of the static-reducing vehicle seat 20 is shown having a static-reducing mat or layer 38, preferably inserted into the seat cushion 21 beneath the seat cover 24 at the seam 32 in the forward portion of the seat cushion 21. The static-reducing layer 38 is preferably a soft and comfortable pad or mat constructed at least partially from a moisture absorbent foam or similar material. Once inserted or included within the seat cushion 21, the static-reducing layer 38 absorbs humidity or moisture from the occupant 15 (see FIG. 1) and from the surrounding environment of the passenger compartment 11 to thereby reduce or minimize the electrostatic charge that is generated or built up on the upholstery or seat cover 24 of seat cushion 21, and that is ultimately transferred to occupant 15. Alternately, the static-reducing layer 38 may take the form of a flexible metallic conductive layer that is sprayed or otherwise directly applied to the interior or reverse side of seat cover 24, so that the static-reducing layer 38 is in contact with the occupant 15 through the pores or openings (not shown) in the seat cover 24.

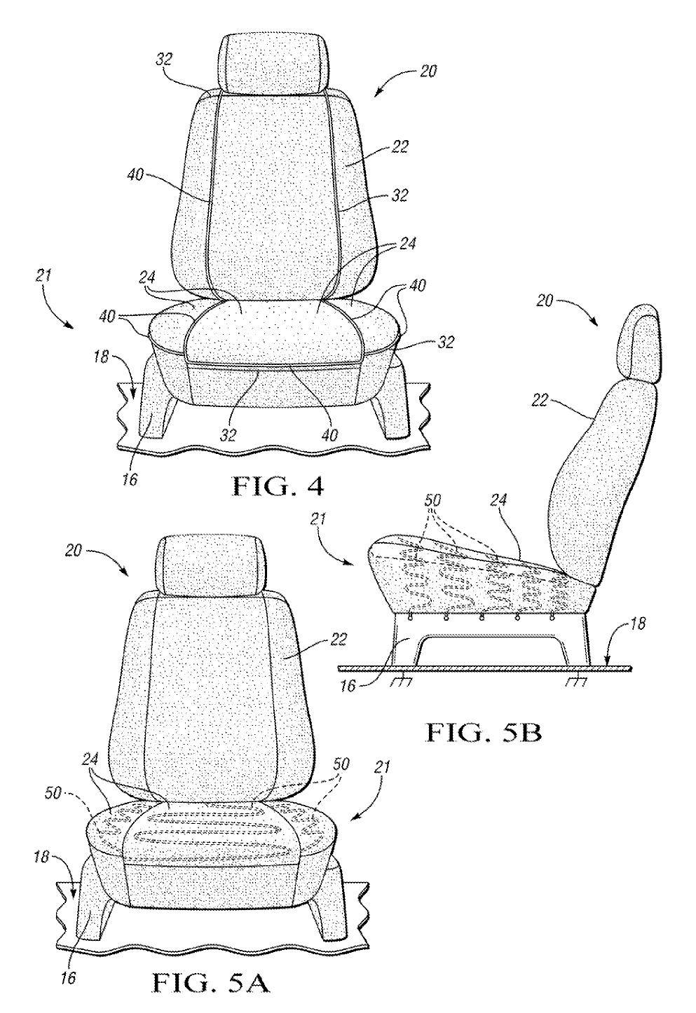

A third embodiment of static-reducing vehicle seat 20 is shown in FIG. 4 having relatively thick, decorative threads or conductive piping 40 positioned along the various seams of the seat 20. The conductive piping 40 is constructed at least partially of conductive material, which as explained previously hereinabove, may include any material known to be a relatively efficient conductor of electricity, such as copper, other metals, and/or conductive plastics and/or resins. Conductive piping 40 is preferably sewn, stitched, or otherwise attached to the static-reducing seat 20 in such a manner as to trim or finish the various seams 32. The locations or positions of the conductive piping 40 on the seat 20 are preferably selected based on the proximity of the piping 40 to the occupant 15 or positions or locations on the seat 20 having an increased probability of sustained contact with the occupant 15 (see FIG. 1). For a consistent, aesthetically pleasing finish, however, various seams not in direct or sustained contact with an occupant 15 are preferably also similarly finished with conductive piping 40.

Turning to FIG. 5A, a fourth embodiment of an static-reducing vehicle seat 20 is shown having a plurality of conductive wires 50 integrated, positioned, or arranged along one or both of the seat cushion 21 and back cushion 22 of the vehicle seat 20 beneath the seat cover 24 along seat cushion 21. The conductive wires 50 are preferably constructed from a conductive metal such as copper and/or conductive plastics and/or resins, and are positioned directly beneath the seat cover 24. The conductive wires 50 are arranged to maximize the area of contact between the conductive wires 50 and an occupant 15 seated on seat cushion 21, preferably in a pattern or position that maximizes the amount of surface area of the conductive wires 50 in contact with the occupant 15. See FIG. 5A, and/or integrated into a heating pad (not shown) within the seat cushion 21. While the conductive wires 50 are preferably integrated into and along the surface of seat cushion 21 due to the high likelihood of sustained contact between an occupant 15 and the static-reducing seat 20 provided at that location, conductive wires 50 may also be inserted or included in other surface components of the seat 20, such as along the back cushion 22, within the scope of the invention.

Finally, as shown in FIG. 5B, which is a side view of the static-reducing seat 20 described hereinabove with reference to FIG. 5A, the conductive wires 50 are also integrated vertically within the static-reducing seat 20 and extend downward, i.e. toward the floor 18, to contact or connect with the seat frame 16, which in the fourth embodiment is preferably constructed using conductive materials. In this manner, an accumulated electrostatic charge carried or transmitted away from the seat cushion through the conductive wires 50 will be effectively dissipated through the seat frame 16 to the vehicle floor 18, and ultimately conducted to ground surface 14 (see FIG. 1) and dissipated, weakened, or otherwise spread out along the entirety of the remaining surface area of the vehicle 10 before an electrostatic discharge may occur between an occupant 15 and the vehicle 10.

While the best modes for carrying out the invention have been described in detail, those familiar with the art to which this invention relates will recognize various alternative designs and embodiments for practicing the invention within the scope of the appended claims.

1. A static-reducing seat for use within a vehicle, said seat being configured for carrying an occupant of said vehicle and including at least one seat cushion having a static-reducing device positioned in sufficient proximity to said occupant for dissipating an electrostatic charge from said seat.

2. The seat of claim 1, wherein said static-reducing device is selected from the group of conductive threading, conductive wiring, and a humidity-absorbing layer.

3. The seat of claim 2, wherein said seat cushion includes an outer seat cover, wherein said static-reducing device is said conductive threading, and wherein said conductive threading is woven into said outer seat cover.

4. The seat of claim 2, including a conductive seat base, wherein said static-reducing device is said conductive wiring, and wherein said conductive wiring is connected to said conductive seat base to thereby form a conductive path for dissipating said electrostatic charge.

5. The seat of claim 2, wherein said static-reducing device is said conductive threading, and wherein said conductive threading is constructed at least partially of conductive metal.

6. A static-resistant vehicle seat adapted to carry a passenger within a vehicle and comprising:
a seat cushion having an outer cover;
a conductive base; and
a static-reducing device configured to reduce the amount of static charge generated on a surface of said outer cover to thereby minimize any electrostatic discharge occurring between the passenger and the vehicle when the passenger exits the vehicle.

7. The static-resistant vehicle seat of claim 6, wherein said static-reducing device includes conductive threading woven into said surface of said outer cover and is adapted to conduct said static charge away from said surface to said conductive base.

8. The static-resistant vehicle seat of claim 7, including a plurality of seams and conductive piping adapted to trim said plurality of seams, wherein said conductive piping is at least partially formed with said conductive threads.

9. The static-resistant vehicle seat of claim 6, wherein said static-reducing device is comprised of at least one conductive wire positioned within said outer cover and adapted to dissipate an electrostatic charge from said outer cover to said conductive base to thereby minimize said electrostatic discharge.

10. The static-resistant vehicle seat of claim 6, wherein said static-reducing device is a mat positioned within said seat cushion and adapted to absorb and retain humidity to thereby minimize the build-up of said static charge on said outer cover.

11. A vehicle comprising a floor, a vehicle seat having a cushion configured for carrying a passenger, and a base supporting said cushion and mounted to said floor, said cushion being operatively connected to said base and further having a static-reducing device adapted to reduce or dissipate an electrostatic charge on said cushion to thereby minimize an electrostatic discharge occurring between said passenger and said vehicle when said passenger exits said vehicle.

12. The vehicle of claim 11, wherein said base is conductive, and wherein said static-reducing device includes a conductive wire forming a conductive path between said vehicle seat and said floor through said base to thereby reduce said electrostatic charge on said cushion.

13. The vehicle of claim 11, including a seat cover that wraps said cushion, wherein said static-reducing device includes conductive thread suitable for conducting said charge away from said seat cover to thereby minimize said electrostatic charge on said cushion, and wherein said conductive thread at least partially forms said seat cover.

14. The vehicle of claim 13, wherein said seat includes a plurality of seams and piping positioned to finish said seams, said conductive thread at least partially forming said piping.

15. The vehicle of claim 11, including a seat cover, wherein said static-reducing device is a humidity-absorbing mat positioned within said cushion below said seat cover for dissipating said electrostatic charge on said cushion.

16. The vehicle of claim 11, wherein said static-reducing device includes a conductive wire suitable for forming a conductive path between said vehicle seat and said floor through said base to thereby reduce said electrostatic charge on said cushion.
